(19) United States
(12) Patent Application Publication
(10) Pub. No.: US 2005/0263080 A1
(43) Pub. Date: Dec. 1, 2005

(54) Absorbent material for animal bedding

(76) Inventors: Timothy L. Campbell, Sylva, NC (US); Denny C. Mathis, Sylva, NC (US); Wendell C. Godfrey, Arden, NC (US); Donald D. Arrington, Sylva, NC (US)

Correspondence Address: PAUL, HASTINGS, JANOFSKY & WALKER LLP, P.O. BOX 919092, SAN DIEGO, CA, 92191-9092, US

(21) Appl. No.: 11/067,295

(22) Filed: Feb. 25, 2005

Related U.S. Application Data
(63) Continuation-in-part of application No. 10/792,686, filed on Mar. 2, 2004.

(51) Int. Cl. A01K 29/00

(52) U.S. Cl. 119/28.5

(57) ABSTRACT

The present invention is directed towards an absorbent material for use as a bedding for animals comprising an absorbent layer comprising OCC or Kraft clippings and gypsum, and a support layer comprising OCC or Kraft clippings and gypsum. The absorbent layer may be fluted and may contain AKD sizing, and the support layer may contain AKD sizing. The present invention also is directed to a method for providing animal bedding for animals by dispersing the absorbent material of the present invention about an area in which the animals are housed. In addition, the present invention is directed to a method of making a multi-layer absorbent material.

The present application claims priority as a continuation-in-part under 35 U.S.C. § 120 to U.S. patent application Ser. No. 10/792,686, entitled “ABSORBENT MATERIAL FOR ANIMAL BEDDING,” filed Mar. 2, 2004, which is incorporated herein by reference in its entirety.

### FIELD OF THE INVENTION

The present invention relates to an absorbent material suitable for use as animal bedding.

### BACKGROUND OF THE INVENTION

Throughout the United States integrated poultry producers contract with independent farmers to grow chicks until they reach market weight. The poultry companies supply the chicks, vaccines, health care, feed and service personnel to the growers; while the growers supply the utilities (e.g., electricity, propane, water), housing and management. Growers often encounter problems in managing poultry flocks, such as high ammonia, high moisture, dust, and cross-contamination with bacteria deposited in feces of chickens. These conditions can deleteriously affect the health of a poultry flock through disease, increased mortality, and reduced feed conversion rates, and are often the result of environmental extremes that cannot be easily controlled by the growers. In an effort to mitigate these conditions, growers often line their poultry houses with a bedding material. But the humidity within chicken houses often climbs during rainy conditions, and water from poultry drinking systems frequently contacts the bedding. These conditions make the bedding more moist, and facilitates bacterial growth. Bacteria convert the uric acid in chicken feces to ammonia, which degrades the overall quality of the housing environment again leading to a decrease in the overall health and quality of a poultry flock.

Wood shavings, sawdust, peanut hulls and rice hulls are the most common types of poultry bedding. Rice hull and peanut hull use typically is restricted to areas near where rice and peanuts are grown, while wood shavings and sawdust are the most common types of poultry bedding used by the rest of the poultry growing industry. Wood shavings products are highly variable in moisture content, size, shape, and type. Some geographical areas use mostly hardwood, others softwood, and many use mixtures which vary depending upon what the supplying wood processing plant is producing at the time. Growers typically resort to these materials because they are relatively inexpensive.

Wood shavings, rice hulls or peanut hulls bond poorly with the nitrogen and phosphorous compounds generated in chicken droppings. Since the typical poultry grower leaves the bedding in place for a year or longer, significant amounts of ammonia and phosphate can accumulate in the bedding over time. There are numerous documented poultry health and economic issues which are attributable to the use of such prior art beddings. For example, high ammonia levels can cause ammonia blindness in birds, and have been shown to irritate the linings of the chickens' lungs and air sacs resulting in opportunistic infections such as air sacculitis and other diseases. Additionally, birds that lay down in litter with high ammonia levels can suffer skin irritation, causing numerous skin defects and infections, potentially reducing the grade a particular bird may receive during processing.

When the wood shavings, rice hull or peanut hull bedding is judged to be spent, or some arbitrary life cycle is reached, it is removed from the poultry house and dispersed in fields as fertilizer. At this stage it is called “poultry litter.” Wood shavings, peanut hull litter and rice hull litter release the ammonia and phosphates very rapidly in the field and may cause environmental hazards in soil types that already have abundant quantities of these nutrients.

Post consumer, recycled or waste paper materials are an attractive alternative to these prior art beddings because such paper materials are relatively inexpensive, and are straight forward to manufacture. While there have been experiments with waste-paper-based animal bedding, none have proven adequately useful. Bedding derived from unprocessed waste materials, such as cardboard or old newspapers, is highly variable, and contains significant contamination in the form of metals, plastics, and sticky components which could pose a health hazard to the animals. Other examples include shredded newsprint, which tends to “cake” or stick together and have significant ink residues. Another approach combines cotton fibers with old newspapers and gypsum, but this product cannot be produced conveniently, because it clogs modern processing equipment. Another animal bedding product is made from bleached pulp, which is too expensive for large volume uses such as poultry bedding.

U.S. Pat. No. 2,708,418 to Sugarman, et al. discloses an animal bedding material made from paper pulp.

U.S. Pat. No. 3,828,731 to White discloses an animal bedding material made primarily of alphacellulose paper stock fibers.

U.S. Pat. Nos. 6,386,144 and 6,399,185 to Cathey disclose an animal bedding material manufactured from a combination of waste paper, waste cotton material and gypsum.

These prior art animal bedding products all suffer from one disadvantage or another. For example, animal bedding products which contain significant amounts of cotton fiber, such as those disclosed in the Cathey patents, pose manufacturing problems because the cotton fibers tend to clog the manufacturing equipment. In addition, the Cathey materials contain significant concentrations of old newsprint (ONP), which causes significant caking problems. Other prior art bedding products fail to provide a healthy environment for the animals.

We have created novel animal bedding materials that may provide significant benefits to integrated poultry producers, address problems encountered in manufacturing, use, or cost of various materials currently used, and which may produce a larger, healthier and more vigorous bird for processing. Potential advantages of the novel animal bedding materials, particularly with respect to poultry, include decreased incidence of disease, increased yield and weight gain, increased feed conversion, increased average grade for poultry produced, decreased skin defects, and reduced mortality, among others.

In addition, once spent as poultry litter the novel animal bedding materials may provide better fertility, reduce migration of nitrogen into ground waters, and reduce rapid leaching of phosphates into surface waters.

### SUMMARY OF THE INVENTION

One aspect of the present invention is directed towards a cotton-fiber-free absorbent material for use as a bedding for animals comprising an absorbent layer and a support layer. The absorbent layer is comprised of gypsum and material prepared from fibers derived from old corrugated containers (“OCC”), kraft clippings or similar used or unused corrugating materials. The support layer is comprised of gypsum and a material prepared from fibers derived from OCC, kraft clippings, or similar used or unused corrugating materials. During manufacturing, the OCC or kraft clippings are highly purified to remove any containments, such as metals, plastics, ink, etc. The absorbent layer may or may not be fluted. Both the support layer and the absorbent layer may or may not contain AKD sizing (i.e., alkyl ketene dimer), although the inclusion of AKD sizing in both layers is preferred.

In another aspect of the present invention, a method for providing animal bedding to a plurality of animals is disclosed, which comprises dispersing throughout the area where animals walk, sleep, roost, or are contained, any of the various product configurations of the animal beddings discussed herein. In still a further aspect, the present invention also includes methods for preparing any of the various animal bedding products discussed herein, including methods of purifying the recycled raw materials, to ensure a high quality animal bedding, with virtually no residual contaminants.

Further features and advantages will become apparent from the detailed description of preferred embodiments which follows, when considered together with the attached claims and drawings.

### BRIEF DESCRIPTION OF THE DRAWINGS

FIG. 1 is a cross-section diagram of an absorbent animal bedding, containing a fluted absorbent layer, and a substantially planar support layer

FIG. 2 is a block diagram illustrating the steps for preparing an absorbent material of the present invention.

FIG. 3 is a block diagram illustrating, in detail, steps for preparing an absorbent layer sheet of the present invention.

FIG. 4 is a block diagram illustrating, in detail, steps for preparing a support layer of the present invention.

FIG. 5 is a diagram illustrating a process for fluting the absorbent layer and combining it to the support layer.

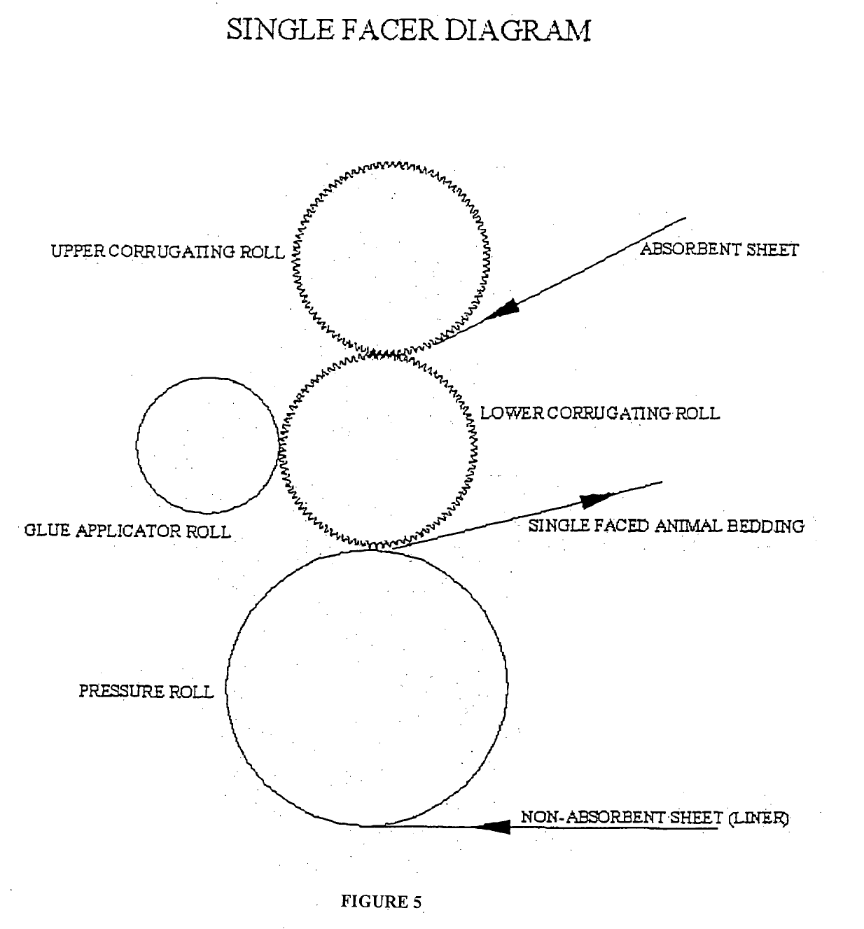

### DETAILED DESCRIPTION OF THE PREFERRED EMBODIMENTS

In using the term “corrugated fibers” to describe the present invention, it is intended that this term be given the broadest possible definition as would be understood by persons of ordinary skill in the art. In particular, “corrugated fibers” as used herein, is intended to include any cellulose-based, flexible material made usually in sheets from a pulp prepared from OCC, kraft clippings, DLK (i.e., Double-Lined Kraft), or similar corrugating structural materials. Besides wood-based pulp products, corrugated fibers may be prepared from pulp derived from linen, straw, bamboo, esparto grass or hemp, or other like materials, as would be understood by persons of ordinary skill in the art.

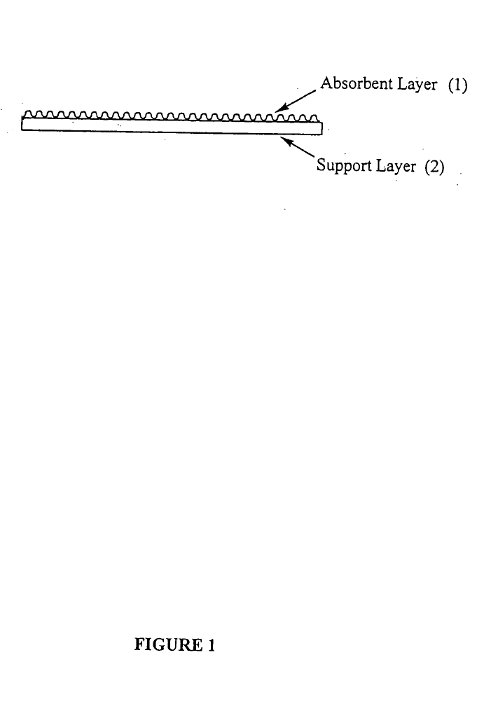

One embodiment of the present invention is directed towards a multi-layer absorbent material for use as animal bedding comprising (a) an absorbent layer comprising corrugated fibers and gypsum; and (b) a support layer comprising corrugated fibers and gypsum. In a preferred embodiment, at least one, and most preferably both the absorbent and support layers are cotton-free. In another preferred embodiment, AKD sizing or other like material may be added to both layers to change the absorbance. In still another preferred embodiment, the absorbent layer may be fluted by methods known to persons of skill in the art, before combining it with the support layer. In a preferred embodiment, the take-up factor for the absorbent layer relative to the support layer may be from about 1.35 to about 1.75, such that for every 1000 linear feet of support layer the absorbent material contains about 1350 to about 1750 feet of absorbent layer. In a most preferred embodiment, the take-up factor is about 1.45 to about 1.55. FIG. 1 illustrates a fluted embodiment, with the fluted absorbent layer 1 being adhered to the support layer 2.

Fluting the absorbent layer allows for more air flow, which allows the absorbent layer to dry faster, thereby extending the useful life of the bedding. Fluting the absorbent layer also increases the surface area to volume ratio of the bedding, effectively increases the long-term absorptive capacity of the animal bedding, and assists in providing a drier and, therefore, healthier environment for the animals. Finally, fluting the absorbent layer also allows the animal bedding to better withstand animal traffic, resist compaction, and minimizes animal contact with areas that have been soiled with fresh droppings.

The relative liquid absorbance of the absorbent layer and the support layer of the present invention may be expressed in terms of their water penetration values or as absorbance capacity relative to weight. In either event, the absorbent layer should exhibit sufficient absorbance so as to provide the animals with a relatively dry environment whereas the support layer should be relatively resistant to liquid absorption so as to preserve its structural support function.

The absorbent layer of the present invention has a water penetration value of less than about 5 minutes. Preferably, the water penetration value of the absorbent layer is less than about 3 minutes. The support layer of the present invention has a water penetration value of greater than or equal to about 1 minutes. Preferably, the water penetration value of the support layer is between about 2 minutes and about 15 minutes.

Corrugated materials that may be included in the absorbent and support layers of the present invention may be derived from old corrugated containers (“OCC”), corrugating medium, corrugated board, double-lined Kraft clippings, or the like. Corrugated fibers derived from any of these materials may be mixed or combined with one another, depending on various qualities designed in the final product or to facilitate manufacturing. For economic reasons, it is especially desirable to use waste or recycled products as raw materials, in at least one, and most preferably both the absorbent layer and the support layer. For example, the corrugated fibers may be derived from old corrugated cardboard commonly known as OCC #11, or double-lined Kraft clippings which may be, for example, the waste material commonly known as DLK #13. The numbers following each grade of waste paper cited above correspond to definitions in the current Institute of Scrap recycling Industries Scrap Specification Circular 2002, the entire contents of which are expressly incorporated herein by reference. Still other such recycled or waste paper products may be used as a source of corrugated fibers, as may become apparent to persons of ordinary skill in the art.

Gypsum may be included in the absorbent and support layers of the present invention, including, for example, natural gypsum, gypsum obtained from recycled wallboard as well as gypsum obtained in by-product form. Gypsum in any of the specified forms absorbs nitrogen and phosphorus compounds.

The absorbent and support layers of the present invention, taken together, may contain from about 80% to about 99% by weight of corrugated fibers, and from about 1% to about 20% by weight gypsum. Individually, the absorbent layer may contain from about 75% to about 95% by weight of corrugated fibers, and from about 5% to about 25% by weight gypsum. The support layer may contain from about 80% to about 100% by weight corrugated fibers, and from 0% to about 20% by weight gypsum. In a preferred embodiment, from about 0.0005% to about 0.017% by weight AKD sizing, containing from about 12% to about 16% by weight solids, may be added to either or both layers.

In still another embodiment, additional layers with varying concentrations of gypsum or AKD sizing, or different or varying degrees of filling may be added to the animal bedding, in order to create different properties, such as increasing the absorptivity, increasing the structural strength, or combinations thereto. By way of example, a semi-absorptive layer may be included between the absorbent and support layers. In addition, an impermeable layer may optionally be included to protect animal enclosures or to facilitate handling.

In still another embodiment of the present invention, the support layer may be omitted entirely, provided that the absorbent layer is cotton-fiber-free, and is fluted as previously described.

In still another embodiment of the present invention, the absorbent layer or the support layer may be treated with various additives, known to persons of skill in the art, to provide the desirable properties or otherwise enhance the animal bedding. Such additives may include aluminum sulfate (i.e., alum), boric acid and selected antimicrobial agents. Alum may be added to the absorbent and/or support layers in an amount from about 5 pounds per ton to about 20 pounds per ton. Alum may act to control the amount of ammonia and soluble phosphorus and as a fire retardant. Examples of antimicrobial agents include Byocoat™.

It is anticipated that the novel animal beddings discussed herein will have a lifespan of about a year or more. An animal bedding may be removed at the end of its lifespan and incinerated in an environmentally sound manner, or applied as fertilizer in areas where soil nutrient requirements are not exceeded by the spent animal bedding.

The present invention is also directed towards a method for providing absorbent materials such as those described above, for use as animal bedding or otherwise to line the enclosures or housing wherein a plurality of animals are housed. The method includes dispersing about the area over which animals are housed, such as the floor or elevated row of a poultry house, any of the absorbent bedding materials according to any aspect of the present invention. In one preferred embodiment the animal bedding of the present invention is used to provide bedding for poultry, such as chickens or turkeys. The multi-layer sheets are preferably shredded prior to dispersing within the animal housing. Given the anticipated lifespan of one year or more, the absorbent bedding materials can be used for multiple flocks of chickens, without changing or supplementing the bedding.

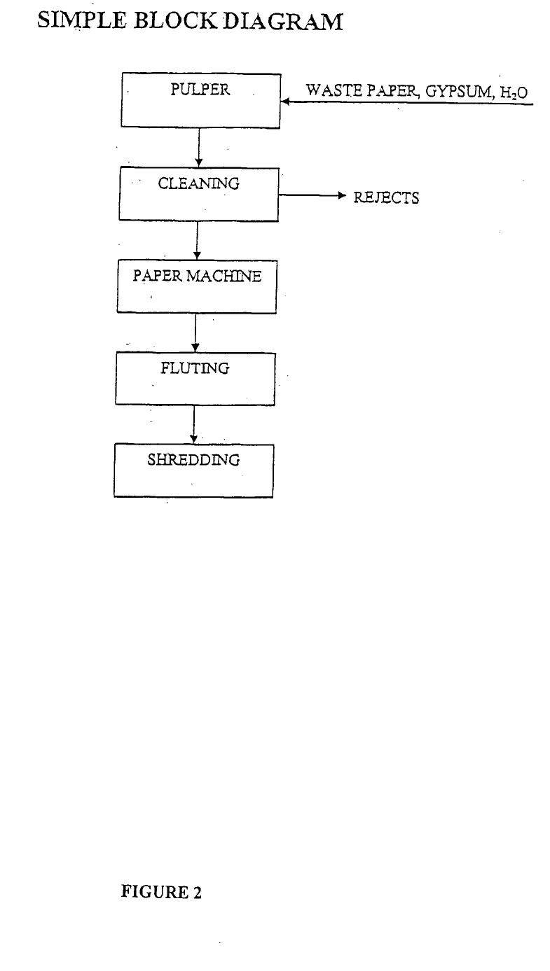

In another embodiment, the present invention is directed towards a method for preparing the absorbent material of the present invention. In particular, the method involves steps which allow for high purification of recycled OCC raw materials. The method includes the steps of: (a) preparing an absorbent layer sheet comprising corrugated fibers and gypsum; and (b) preparing a support layer sheet comprising corrugated fibers and gypsum; (c) fluting the absorbent layer sheet; and (d) combining the fluted absorbent layer sheet and the support layer sheet to each other. Optionally, the absorbent sheet may be adhered to the support sheet, by applying an adhesive between the layers. FIG. 2 discloses the method in more detail. In a further embodiment, the method involves the further step of shredding the product of step (d) to provide a shredded, two-layer absorbent product. The shreds may range from fines to 2 inches in diameter but a preferred embodiment between about ¾ to and about ½ inch in diameter. It is understood by persons of skill in the art that the cross-sections of shreds may be substantially circular, substantially elliptical, substantially square, substantially rectangular or substantially any other geometric shape, so long as the longest measurement from end to end does not equal 2 inches in length. In a still further embodiment, steps (b) and (d) are omitted, and the fluted absorbent layer alone, is simply shredded and then used directly as an animal bedding.

A sheet of the absorbent layer of the present invention may be prepared by the following process: (a) mixing a pulp or paper-based material, containing corrugated fibers, gypsum and water; (b) pulping the mixture of step (a); (c) removing unwanted contaminants from the pulp obtained in step (b); (d) increasing the consistency of the product of step (c); and (e) passing the product of step (d) through a paper machine to provide an absorbent layer sheet. The support layer sheet may be prepared in a similar manner. In both layers the addition of AKD sizing to paper machine step (e), may be included.

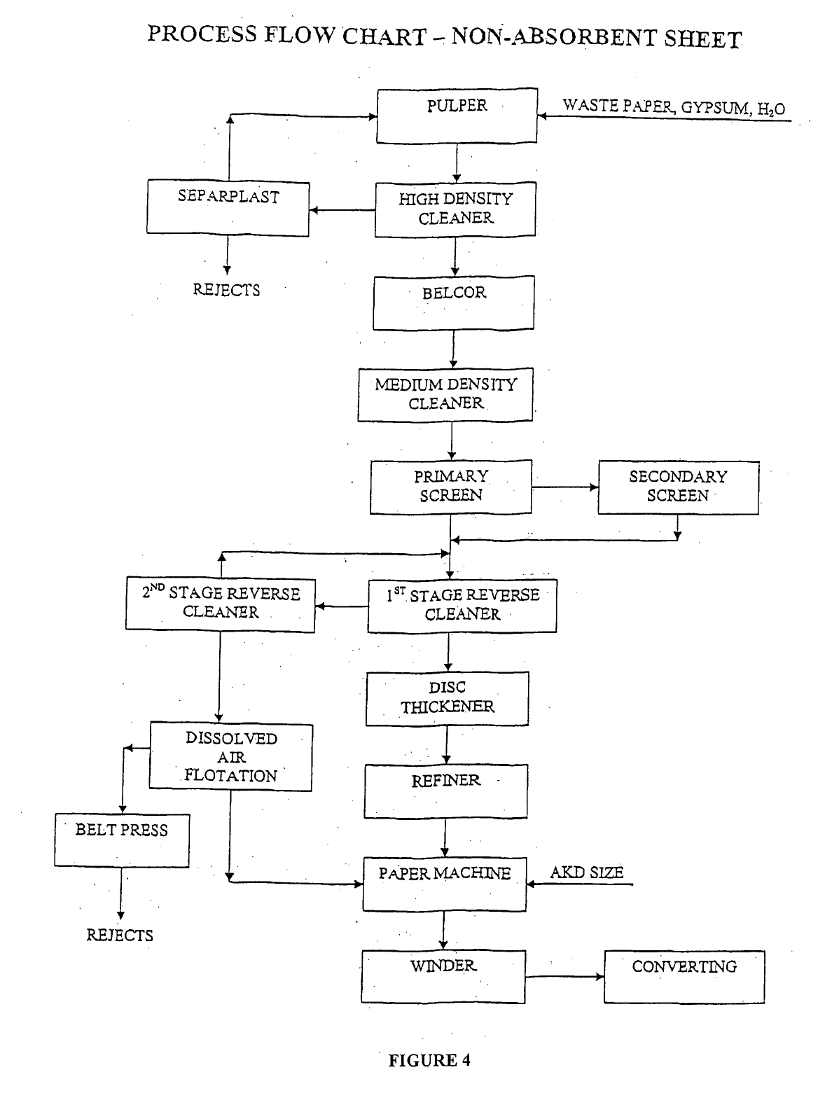

In addition, the absorbent material of the present invention may be further prepared by fluting the absorbent layer sheet and combining the fluted absorbent layer sheet with the support layer sheet to each other. This may be accomplished by, for example, passing the absorbent layer sheet and the support layer sheet through an apparatus such as that shown in FIG. 4. Optionally, an adhesive may be applied to the layers to adhere the absorbent layer to the support layer. The resultant absorbent material may then be shredded.

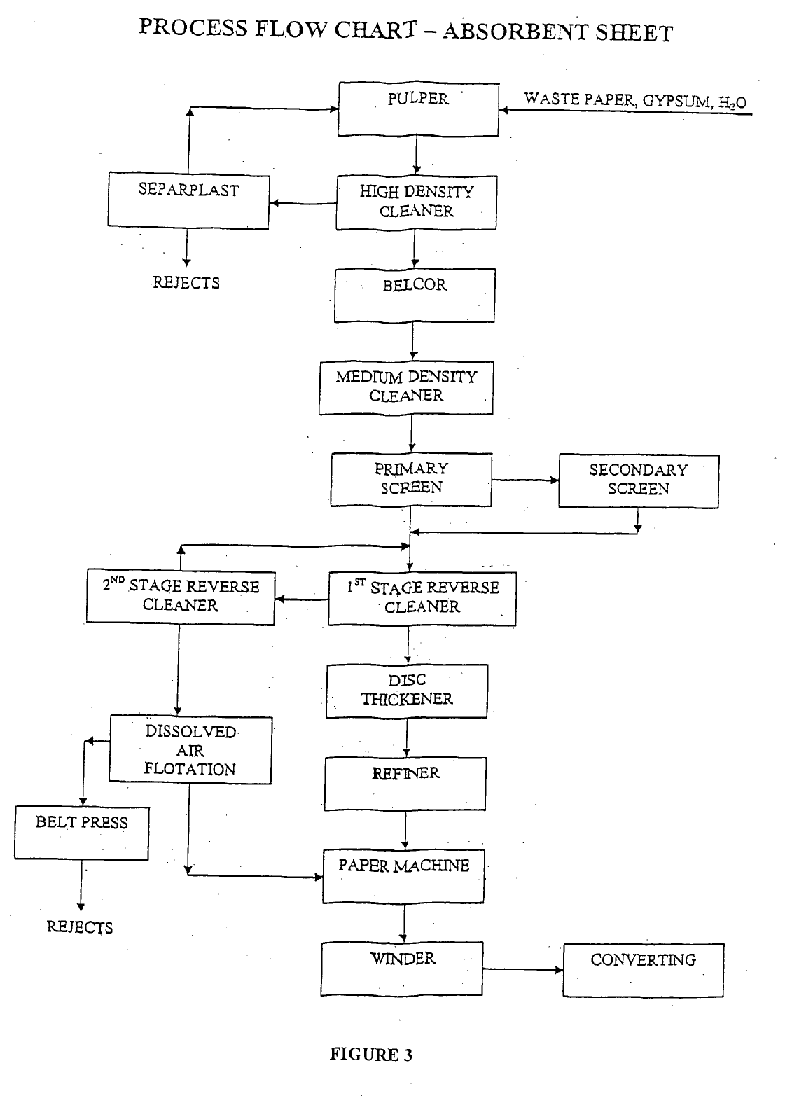

FIG. 3 is a detailed process flow diagram illustrating the steps for preparing a sheet of the absorbent layer of the present invention. In the first step, a pulp containing corrugated fibers, gypsum and about 92% to about 98% water are mixed and passed through a pulper. The resultant pulp may be cleaned through a series of steps to remove unwanted waste products such as, for example, metal, glass, rocks, sand, styrofoam, and fiber bundles. The raw materials may be pulped in a conventional tub pulper with ragger and scavenger. An alternative would be a drum pulper, following wire removal. Pulper temperature is controlled to a range of between about 100° F. and about 120° F., preferably between about 110 to about 118 degrees Fahrenheit. The pH is controlled between a range of about 6.5 and about 8, preferably between about 7.0 and about 7.5, measured at the paper machine.

The resultant material is then passed through a high density cleaner to remove heavy contaminants such as, for example, bolts, wire, glass and rocks. Next, the material is passed through a Belcor® or similar pulper trash separation device to remove intermediate sized pieces of plastic and metal such as, for example, paper clips and staples. A Maule® Sepraplast, or similar device, may then be used to collect material removed by the high density cleaner and/or Belcor® and to recycle any desirable material back into the pulper. After the Belcor®, the resultant material passes to a medium density cleaner which removes additional high density material such as, for example, grit, sand, and small pieces of metal and glass. The material then passes through a primary screen with a hole size ranging from about 0.082 to about 0.102 inches. Typically, the hole size is about 0.092 inches. The primary screen removes fiber bundles, strings, styrofoam and small pieces of plastic. The material rejected by the primary screen is passed through a secondary screen with a hole size ranging from about 0.068 to about 0.088 inches. Typically, the hole size is about 0.078 inches. Material accepted by either the primary screen or the secondary screen passes through a first stage reverse cleaner, which removes light contaminants such as, for example, styrofoam, waxes, hot melts and small pieces of plastics. The rejected material passes through a second stage reverse cleaner and is then either re-introduced into the first stage reverse cleaner or passed through a dissolved air flotation unit. Material rejected by the dissolved air flotation unit is removed from the system, whereas material accepted by the unit is sent to a paper machine.

A sheet of the absorbent layer of the present invention may then be formed on a conventional paper machine using the following steps or equipment. Material accepted by the first stage cleaner passes through a disc thickener. This step thickens the paper-based material, gypsum and water mixture in preparation for the paper machine. After passing through the disc thickener the material passes through a refiner, which is used in the paper making process to cut or refine stock to a desired freeness for processing. The refining capacity should be sufficient to achieve a freeness drop of 100 Canadian Standard. After passing through the refiner, the material passes through a paper machine, where the AKD sizing is added prior to desired stock mixture being made into paper form. The drainage and vacuum capacity should be sufficient to provide about 25 to about 28% dryness at the couch roll position before the sheet enters the presses. In addition, the pressing capacity should achieve a dryness of about 45% before the sheet enters the dryers and the drying capacity should be sufficient to achieve a dryness of about 90% at the reel. The absorbent layer sheet has a basis weight range of between about 32 to 40 pounds per thousand square feet, and a moisture content of between about 9 and 12%.

The winder and converting steps are used to roll the product into reel form, flute the absorbent sheet and combine with the support sheet. Adhesive may be added during this step.

FIG. 4 is a block diagram illustrating the steps for preparing a sheet of the support layer of the present invention. It is identical to FIG. 3, except that the AKD sizing or material that functions similarly, may provide higher water penetration values than the absorbent layer.

Because neither the absorbent layer, nor the support layer contains any cotton, the absorbent material of the present invention are much simpler to manufacture and avoid clogging the manufacturing equipment.

The fluting and/or combining steps may be accomplished using, for example, the equipment illustrated in FIG. 4, sometimes referred to as a single facer. Adhesive may also be added as the layers pass through the single facer. Other equipment, well known to persons of skill in the art may also be used to accomplish these steps. FIG. 4 is a diagram illustrating a process for fluting the absorbent layer and combining it with the support layer. The upper and lower corrugating rolls are used to flute the absorbent layer, the glue applicator roll adheres glue to the fluted absorbent layer, and the pressure roll puts the support layer in contact with the absorbent layer so as to make the combined multi-layer absorbent material of the present invention.

The product may then be shredded. The combined layers, absorbent and support, may have a density of between about 1.5 and about 9 pounds per cubic foot at the shredder discharge, preferably between about 4 and about 6 pounds per cubic foot.

### EXAMPLE 1

As an initial test, a comparison of ammonia levels, appearance and caking of various absorbent materials prepared according to the present invention with other materials was performed. Table 1 provides the results. With respect to the concentrations of corrugated fibers and gypsum, where two numbers are provided in a column, the first number indicates the level present in the absorbent layer and the second number indicates the level present in the support layer. Where only one number is provided, the material was not passed through the single facer equipment illustrated in FIG. 4, and was tested as a single layer absorbent product. The concentration of ammonia is reported in ppm relative to a standard level of ammonia, which is set at 0 ppm. Consequently, levels of ammonia measured below the standard level indicate a negative value.

TABLE 1
Comparison of Various Poultry Bedding Samples

| | | | | AKD | | | |
|---|---|---|---|---|---|---|---|
| | Corrugated | | | Sizing | | | |
| Sample | Fibers | Newsprint | Gypsum | Added | NH4 | | |
| No. | (wt. %) | (wt. %) | (wt. %) | (Y/N) | (ppm) | Appearance | Caking |
| 1 | | | | | 3 | | very poor |
| 2 | | | | | 4 | | very poor |
| 3 | | | | | 8 | | very poor |
| 4 | 30; 30 | 30; 30 | 40; 40 | N; N | 3 | Poor | ok |
| 5 | 43; 43 | 43; 43 | 14; 14 | N; N | 4 | Very poor | poor |
| 6 | 0; 0 | 99; 99 | 1; 1 | Y; Y | 3 | Good | poor |
| 7 | 93; 93 | 0; 0 | 7; 7 | N; N | 8 | Very good | okay |
| 8 | 63 | 23 | 14 | N | 6 | fairly good | okay |
| 9 | 63; 93 | 23; 0 | 14; 7 | N; Y | 0 | fairly good | okay |
| 10 | 93 | 0 | 7 | Y | 4 | Very good | very good |
| 11 | 92; 93 | 0; 0 | 8; 7 | N; Y | 0 | fairly good | okay |
| 12 | 99 | 0 | 1 | Y | 0 | Very good | very good |
| 13 | 92; 99 | 0; 0 | 8; 1 | N; Y | 0 | Good | okay |
| 14 | 63; 63 | 23; 23 | 14; 14 | N; N | −1 | Poor | poor |
| 15 | 92; 92 | 0; 0 | 8; 8 | N; N | −3 | Good | okay |
| 16 | 92 | 0 | 8 | N | −4 | Very good | very good |
| 17 | 40.5; 40.5 | 40.5; 40.5 | 19; 19 | N; N | 0 | Poor | okay |
| 18 | 63; 99 | 23; 0 | 14; 1 | N; Y | −3 | fairly good | okay |

Samples 1-3 in Table 1 are control samples which are representative of the poultry bedding commonly in use, and are comprised of mixed wood chips and saw dust obtained from mills. Samples 4-6, 8-9, 14, and 17-18 contain substantial concentrations of ONP. As can be seen from Table 1, samples 11-13, 15, and 16 provided the best overall results in this qualitative study. The samples containing ONP, while performing better than the control samples, developed significant caking, and did not perform as well as samples that simply contained corrugated fibers.

Although the foregoing invention has been described in terms of certain preferred embodiments, other embodiments will become apparent to those of ordinary skill in the art in view of the disclosure herein. Accordingly, the present invention is not intended to be limited by the recitation of preferred embodiments, but is intended to be defined solely by reference to the appended claims.

1. A multi-layer, absorbent material for use as a bedding for animals comprising:
an absorbent layer comprising corrugated fibers and gypsum; and
a support layer comprising corrugated fibers.

2. An absorbent material according to claim 2, wherein the support layer further comprises gypsum.

3. An absorbent material according to claim 2, wherein corrugated fibers of at least one of said absorbent layer and said support layer are derived from raw materials selected from the group of OCC, Kraft clippings, and DLK.

4. An absorbent material according to claim 3, wherein the absorbent layer comprises between about 75% to about 95% by weight corrugated fibers, and between about 5% to about 25% by weight gypsum, and the support layer comprises between about 80% to about 100% by weight corrugated fibers, and between 0% to about 20% by weight gypsum.

5. An absorbent material according to claim 4, wherein the absorbent material comprises about 80% to about 90% by weight corrugated fibers, and about 10% to about 20% by weight gypsum.

6. An absorbent material according to claim 5, wherein the absorbent layer is fluted.

7. An absorbent material according to claim 6 wherein the fluted absorbent layer has a take-up factor of about 1.35 to about 1.55.

8. An absorbent material according to claim 7 wherein the absorbent layer further comprises AKD sizing.

9. An absorbent material according to claim 8, wherein the support layer further comprises AKD sizing.

10. An absorbent material according to claim 9, wherein the absorbent layer further comprises between about 0.0005% and about 0.017% and sizing.

11. An absorbent material according to claim 10, wherein the animals are poultry.

12. An absorbent material according to claim 11, wherein said poultry are selected from the group of chickens and turkeys.

13. An absorbent material according to claim 12, wherein the absorbent material is shredded.

14. An absorbent material according to claim 14, wherein said shreds are between about ¾ inch and about 1½ inch in length.

15. A method for providing animal bedding for a plurality of animals comprising dispersing about an animal housing area a cotton fiber free absorbent material which comprises:
an absorbent layer comprising corrugated fibers and gypsum; and
a support layer comprising corrugated fibers and gypsum.

16. A method according to claim 15, wherein the corrugated fibers are derived from raw materials selected from the group of OCC, Kraft clippings, and DLK.

17. A method according to claim 16, wherein the absorbent layer comprises between about 75% to about 95% by weight corrugated fibers, and between about 5% to about 25% by weight gypsum, and the support layer comprises between about 80% to about 100% by weight corrugated fibers, and between 0% to about 20% by weight gypsum.

18. A method according to claim 17, wherein the absorbent material comprises about 80% to about 90% by weight corrugated fibers and about 10% to about 20% by weight gypsum.

19. A method according to claim 18, wherein the absorbent layer is fluted.

20. A method according to claim 19 wherein the fluted absorbent layer has a take-up factor of about 1.35 to about 1.55.

21. A method according to claim 20, wherein the absorbent material is shredded before being dispersed.

22. A method according to claim 19, wherein the animals are poultry.

23. A method according to claim 22, wherein said poultry are selected from the group of chickens and turkeys.

24. A method according to claim 23, wherein said absorbent layer and said support layer comprise AKD sizing.

25. A method according to claim 24 wherein said shreds are between about ¾″ and 1½″ in length.

26. A method for making an absorbent material for use as animal bedding comprising:
(a) providing an absorbent layer by (i) providing an absorbent sheet pulp mixture comprising corrugated fibers, water and gypsum; (ii) purifying said absorbent sheet pulp mixture; and (iii) passing the purified absorbent sheet pulp mixture through a paper machine;
(b) providing a support layer by (i) providing a support sheet pulp mixture comprising corrugated fibers, water and gypsum; (ii) purifying said support sheet pulp mixture; and (iii) passing the purified support sheet mixture through a paper machine; and
(c) combining the absorbent layer and the support layer.

27. A method according to claim 26, further comprising the step of fluting the absorbent layer.

28. A method according to claim 27, further comprising the step of adhering the absorbent layer and the support layer to each other.

29. A method according to claim 28, further comprising the step of shredding the absorbent material.

30. A method according to claim 29, wherein the corrugated fibers are derived from raw materials selected from the group of OCC, DLK and Kraft clippings.

31. A method according to claim 28, wherein the absorbent layer comprises between about 75% to about 95% by weight corrugated fibers, and between about 5% to about 25% by weight gypsum, and the support layer comprises between about 80% to about 100% by weight corrugated fibers, and between 0% to about 20% by weight gypsum.

32. A method according to claim 31, further comprising the step of adding AKD sizing to the pulp mixture of both the absorbent layer and the support layer.

33. A method according to claim 32, wherein between about 0.0005% and about 0.017% AKD sizing is added to the pulp mixture of both the absorbent layer and the support layer.

34. A method according to claim 33, wherein said shreds are between about ¾″ and about 1½″ in length.

35. An animal bedding comprising:
a fluted, absorbent layer comprising corrugated fibers and gypsum and AKD sizing; and
a support layer comprising corrugated fibers, gypsum and AKD sizing.

36. An animal bedding according to claim 35, wherein the fluted absorbent layer has a take-up factor of about 1.35 to about 1.55.

37. An animal bedding according to claim 36, wherein the absorbent layer comprises between about 75% to about 95% by weight corrugated fibers, and between about 5% to about 25% by weight gypsum, and the support layer comprises between about 80% to about 100% by weight corrugated fibers, and between 0% to about 20% by weight gypsum.

38. An animal bedding according to claim 37, wherein said bedding comprises about 80% to about 90% by weight corrugated fibers and about 10% to about 20% by weight gypsum.

39. An animal bedding according to claim 38, wherein the animals are poultry.

40. An animal bedding according to claim 39, wherein the animals are chickens or turkeys.

41. An animal bedding according to claim 40, wherein said animal bedding is shredded into pieces of between about ¾″ inch and about 1½″ inch in length.

42. A cotton fiber free poultry bedding comprising:
a fluted absorbent layer comprising gypsum, AKD sizing and corrugated fibers derived from raw materials selected from the group of OCC Kraft clippings; and DLK and a support layer comprising gypsum, AKD sizing, and corrugated fibers derived from raw materials selected from the group OCC Kraft clippings and DLK.

43. A poultry bedding according to claim 42, wherein the fluted absorbent layer has a take-up factor of about 1.35 to about 1.75.

44. A poultry bedding according to claim 43, wherein said take up factor is between about 1.45 and about 1.55.

45. A poultry bedding according to claim 44, wherein the absorbent layer comprises between about 75% to about 95% by weight corrugated fibers, and between about 5% to about 25% by weight gypsum, and the support layer comprises between about 80% to about 100% by weight corrugated fibers, and between 0% to about 20% by weight gypsum.

46. A poultry bedding according to claim 45, wherein the absorbent layer comprises about 80% to about 90% by weight corrugated fibers and about 10% to about 20% by weight gypsum.

47. A poultry bedding according to claim 46, wherein the absorbent layer and the support layer comprises about 0.0005% to about 0.017% by weight AKD sizing.

48. A poultry bedding according to claim 47, wherein the poultry bedding is shredded.

49. A poultry bedding according to claim 48, wherein said shreds are between about ¾″ and 1½″ in length. A poultry bedding according to claim 48, wherein the poultry are chickens or turkeys.
